(19) United States
(12) Patent Application Publication
(10) Pub. No.: US 2015/0207776 A1
(43) Pub. Date: Jul. 23, 2015

(54) INTELLIGENT IP RESOLVER

(71) Applicants: Drew Morin, Davidsonville, MD (US); Vineet Sachdev, Millersville, MD (US); William Wells, Federal Way, WA (US)

(72) Inventors: Drew Morin, Davidsonville, MD (US); Vineet Sachdev, Millersville, MD (US); William Wells, Federal Way, WA (US)

(73) Assignee: TELECOMMUNICATION SYSTEMS, INC., Annapolis, MD (US)

(21) Appl. No.: 14/502,563

(22) Filed: Sep. 30, 2014

Related U.S. Application Data
(60) Provisional application No. 61/929,825, filed on Jan. 21, 2014.

(51) Int. Cl. H04L 29/12; H04W 80/12

(52) U.S. Cl. CPC H04L 61/2503; H04L 61/10; H04W 80/12; H04L 61/6068

(57) ABSTRACT

An intelligent Internet Protocol (IP) resolver can be configured to receive a domain name service (DNS) request from a node of an external network to resolve a domain name for a content provider accessed via an autonomous network. The intelligent IP resolver can also be configured to determine an entry point into the autonomous network for traffic originating from a mobile device identified in the DNS request. The intelligent IP resolver can further be configured to generate a DNS answer that identifies a node of the content provider. The node of the content provider can be determined based on the entry point of the autonomous network.

### CROSS-REFERENCE TO RELATED APPLICATION

This application claims the benefit of priority to U.S. Provisional Application No. 61/929,825 filed on Jan. 21, 2014, and entitled IP LOCATION RESOLVER FOR MOBILE DEVICES ACCESSING AUTONOMOUS NETWORKS, the entirety of which is herein incorporated by reference.

### TECHNICAL FIELD

This disclosure relates to an intelligent IP resolver.

### BACKGROUND

A local Internet registry (LIR) is an organization that has been allocated a block of Internet Protocol (IP) addresses by a regional Internet registry, and that assigns parts of this block. LIRs can be implemented as Internet service providers, enterprises, or academic institutions.

An Authoritative Name Server is a name server that gives answers in response to questions asked about names in a zone. An Authoritative-only Name Server can return answers only to queries about domain names that have been specifically configured by an administrator. Authoritative Name Servers can also be configured to give authoritative answers to queries in some zones, while acting as a caching name server for all other zones.

Traceroute is a computer network diagnostic tool for displaying the network route (path) and measuring transit delays of packets across an Internet Protocol (IP) network. The history of the network route is recorded as the round-trip times of the packets received from each successive host (remote node) in the route (path); the sum of the mean times in each hop indicates the total time spent to establish the connection. The traceroute function can output, for example a list of traversed routers along the network route, together with timing information.

### SUMMARY

One example relates to an intelligent Internet Protocol (IP) resolver implemented on one or more computers having machine readable instructions. The intelligent IP resolver can be configured to receive a domain name service (DNS) request from a node of an external network to resolve a domain name for a content provider accessed via an autonomous network. The intelligent IP resolver can also be configured to determine an entry point into the autonomous network for traffic originating from a mobile device identified in the DNS request. The intelligent IP resolver can further be configured to generate a DNS answer that identifies a node of the content provider. The node of the content provider can be determined based on the entry point of the autonomous network.

Another example relates to an autonomous network including a plurality of entry points to the autonomous network. Each entry point of the plurality of entry points can be coupled to an external network of a plurality of external networks. The autonomous network can further include an intelligent IP resolver configured to receive a DNS request for a content provider including a plurality of nodes. The DNS request can identify a mobile device operating on an external network. The intelligent IP resolver can also be configured to select a node of the content provider based on a particular entry point of the plurality of entry points in response to the DNS request. Traffic from the mobile device can flow through the particular entry point into the autonomous network.

Yet another example relates to a method that can include receiving a DNS request from a node of an external network to resolve a domain name for a content provider operating on an autonomous network. The method can also include determining whether network architecture and control plane interface information are known for the autonomous network. The method can still further include identifying an entry point into the autonomous network for traffic originating from a mobile device identified in the DNS request, in response to the determination of whether the network architecture and the control plane interface information are known. The method can yet further include determining an IP address for a node of the content provider based on the entry point into the autonomous network.

### BRIEF DESCRIPTION OF THE DRAWINGS

FIG. 1 illustrates an example of a system for resolving an Internet Protocol (IP) location for a mobile device accessing an autonomous network.

FIG. 2 illustrates an example of a system for resolving a domain name for a mobile device accessing an autonomous network.

FIG. 3 illustrates an example of a network system that implements an intelligent IP resolver.

FIG. 4 illustrates an example of a mobile network that implements an intelligent IP resolver.

FIG. 5 illustrates an example of a flowchart of an example method for resolving a domain name.

### DETAILED DESCRIPTION

This disclosure relates to an intelligent Internet Protocol (IP) resolver. The intelligent IP resolver can be configured to receive a domain name service (DNS) request from a DNS server (or other network node) of an external network to resolve a domain name for a content provider associated with and/or accessed via an autonomous network. The DNS request can include an IP address of a mobile device that initiated the DNS request. In some examples, the intelligent IP resolver can operate as an Authoritative Name Server with enhanced operational features.

The intelligent IP resolver can be configured to determine an entry point into the autonomous network for traffic originating from the mobile device identified in the DNS request. The intelligent IP resolver can further be configured to generate a DNS answer that identifies a node of the content provider. The node of the content provider can be determined based at least in part on the entry point of the autonomous network. In this manner, the intelligent IP resolver can ensure that the node of the content provider is selected based at least in part on an actual geographic region in which the mobile device is located. The mobile device can receive the IP address of the node of the content provider via the DNS server. In response, the mobile device can resolve the domain name of the content provider to the IP address of the node of the content provider.

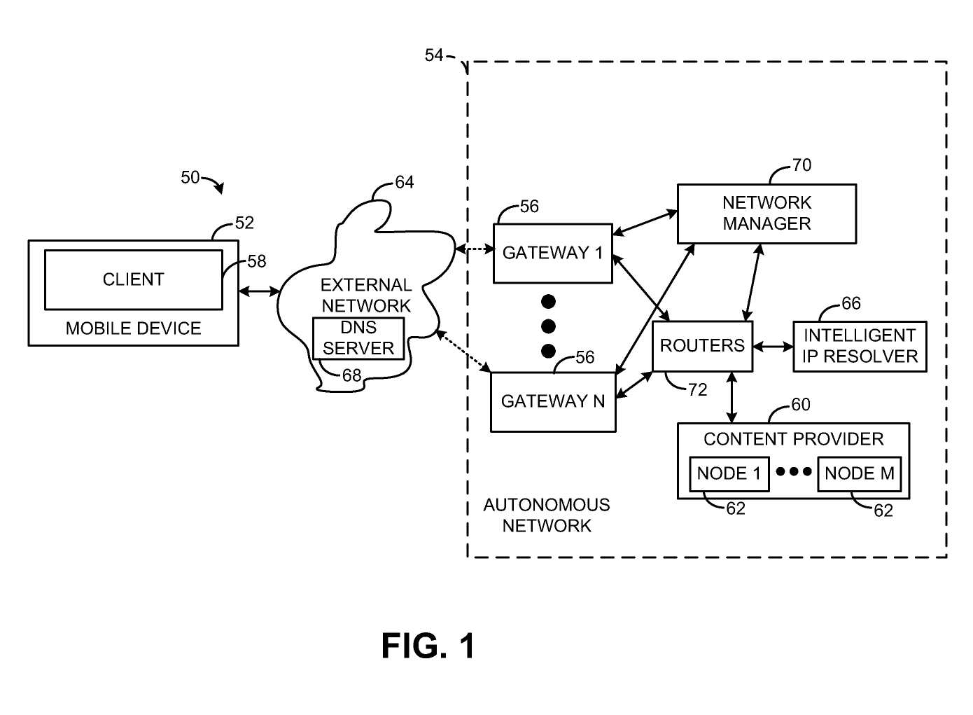

FIG. 1 illustrates an example of a system 50 for resolving an Internet IP location for a mobile device 52 accessing an autonomous network 54. The mobile device 52 could be implemented, for example, as a wireless computing device, such as a laptop computer, a tablet computer, a wireless phone (e.g., a smart phone) or a combination thereof. The mobile device 52 can have an IP address assigned thereto. The IP address of the mobile device 52 can be assigned, for example, by a carrier network (e.g., at a cellular basestation), a WiFi network (e.g., a hotspot), a residential network, etc.

The autonomous network 54 can be implemented, for example, as a wide area network (WAN). As used herein, the term “autonomous network” refers to a collection of connected network nodes with IP routing prefixes under the control of an administrative entity, such as a network operator that presents a trusted, clearly defined routing policy to the Internet. Thus, in the examples given, the network operator of the autonomous network 54 can control routing of packets entering, exiting and/or traversing through the autonomous network 54. The autonomous network 54 can include N number of gateways 56 that operate as entry points (ingress ports) and exit ports (egress ports) of the autonomous network 54. In some examples, each of the N number of gateways 56 can be representative of a packet network gateway, or a combination of a packet network gateway and a serving gateway. In examples where a given gateway 56 of the N number of gateways 56 serves as a combination of a packet network gateway and a serving gateway, the gateway 56 can be configured to have an IP point of presence in both the external networks and the autonomous network 54.

The mobile device 52 can include a client 58 executing thereon that can request content from a content provider 60 that operates on and/or communicates with nodes of the autonomous network 54. It is noted that while the content provider 60 is illustrated in FIG. 1 as being part of the autonomous network 54, it is to be understood that in other examples, the content provider 60 could be implemented on an external network and/or system. The client 58 can be implemented, for example, as an application, such as a browser, a dedicated application or a plugin for a browser. The content provider 60 can be implemented, for example, as one or more computing devices (e.g., servers) that can provide the requested content to the mobile device 52. For instance, the content provider 60 can be a streaming media provider.

The content provider 60 can have M number of nodes 62 configured to respond to requests from different mobile devices, where M is an integer greater than or equal to two. Each node 62 of M number of nodes 62 can be representative of a server (or a virtual server) for the content provider 60. In this manner, the content provider 60 can employ load balancing over the M number of nodes 62 to ensure a proper user experience. Moreover, in some examples, the M number of nodes 62 of the content provider 60 can be geographically diverse, such that a given node 62 of the content provider 60 can be configured to service a specific geographic region.

In some examples, the client 58 of the mobile device 52 can establish communication with an external network 64. The external network 64 can be representative of a public network (e.g., the Internet), a private network or a combination thereof. In some examples, the external network 64 can be operated in compliance with parameters determined by the network operator of the autonomous network 54. For instance, the external network 64 can be implemented as a mobile network that conforms to architectural standards set to meet a protocol standard and/or standards set by the network operator of the autonomous network 54. Alternatively, the external network 64 could be implemented as a private network that provides bandwidth leased from the network operator of the autonomous network 54. For instance, the external network 64 could be a WiFi network that is made available to mobile devices (including the mobile device 52) that are within close proximity (e.g., within a building). In this situation, the external network 64 can be configured to communicate with a particular gateway 56 of the N number of gateways 56.

In other examples, the external network 64 could be implemented as a third party network that is configured independently of the autonomous network 54. For example, the external network 64 could be implemented as another autonomous network 54 that is controlled by another network operator. In this situation, it may not be predictable as to which of the N number of gateways 56 the external network 64 communicates.

As noted, the mobile device 52 can have an IP address assigned thereto. Conventionally, routing algorithms, such as the open shortest path first algorithm (OSPF) are configured to rely on an improper assumption that an IP address of a mobile device 52 corresponds to a geographic location of the mobile device 52. However, due to the inherent nature of travel of the mobile device 52, the geographic location of the mobile device 52 can be significantly different than a geographic location for which the IP address was originally assigned. For instance, a mobile device 52 could have an IP address assigned in New York City and travel to San Francisco while maintaining the same IP address. The autonomous network 54 can include an intelligent IP resolver 66 that can be configured to employ an IP address of a particular gateway 56 of the N number of gateways 56 for the mobile device 52 as a proxy for the IP address assigned to the mobile device 52 as a parameter for the routing algorithm to select a node 62 of the content provider 60 to service content requests from the mobile device 52.

The intelligent IP resolver 66 can be implemented, for example, as a standalone device, such as a network appliance. Moreover, in some examples, the intelligent IP resolver 66 can be implemented as a component executing on another network nodes (e.g., a server or router operating on the autonomous network 54). Further still, in some examples, features of the intelligent IP resolver 66 can be distributed throughout several different computing devices (e.g., as a cloud service).

As an example, a content request can be initiated by the client 58 of the mobile device 52. The content request can identify a domain name of the content provider 60. The client 58 of the mobile device 52 can issue a domain name service DNS request to a DNS server 68 (or other network node) to resolve the IP address of the content provider 60. The DNS server 68 can forward the DNS request, which can include an IP address of the mobile device 52 to the intelligent IP resolver 66 of the autonomous network 54. In this manner, the intelligent IP resolver 66 can operate in place of an authoritative name service and/or another DNS server.

In response, the intelligent IP resolver 66 can be configured to determine an entry point of traffic originating from the mobile device 52 for the autonomous network 54, which, as noted corresponds to a particular gateway 56 of the N number of gateways 56. The particular gateway 56 can be determined in several different ways. In some examples, such as examples where the external network 64 operates under parameters set by the network operator of the autonomous network 54, the intelligent IP resolver 66 can employ control plane messaging to identify which of the N number of gateways 56 is assigned to the mobile device 52, which particular gateway 56 corresponds to the entry point of traffic originating from the mobile device 52. In some examples, the control plane messaging can include a query to a network manager 70. The network manager 70 can be implemented, for example, as components operating on the control plane, wherein network node that can include a policy, charging and routing function (PCRF), a subscriber database and a mobility management node. Additionally or alternatively, the intelligent IP resolver 66 can monitor the control plane of each of the N number of gateways 56 to determine the entry point into the autonomous network 54.

In other examples, such as situations where the external network 64 is operated independently of the autonomous network 54, the intelligent IP resolver 66 can initiate a traceroute function (or similar algorithm) that can track the route of a packet transmitted toward the mobile device 52. In such a situation, the route from intelligent IP resolver 66 to particular a gateway 56 of the N number of gateways 56 can be traced, which particular gateway 56 can be set as the entry point to the autonomous network 54 for the mobile device 52. The route can include, for example, plurality of routers 72 operative between the particular gateway 56 and the intelligent IP resolver 66. It is noted that while the plurality of routers 72 are illustrated in FIG. 1 as a single network node, the plurality of routers 72 can represent a complex network of routing devices present throughout the autonomous network 54 that are each configured to ensure that packets are properly routed through the autonomous network 54.

Upon determining the entry point, which can correspond to one of the N number of gateways 56, the intelligent IP resolver 66 can employ a routing algorithm (including the OSPF and/or a similar algorithm) to select a node 62 of the M number of nodes 62 of the content provider 60 that should be employed by the mobile device 52 to achieve an optimized route through the autonomous network 54. In particular, the intelligent IP resolver 66 can employ the IP address of the particular gateway 56 as a proxy for the IP address of the mobile device 52 such that the parameters of the algorithm related to the location of the mobile device 52 can be based on the entry point of the autonomous network 54 for traffic originating from the mobile device 52 instead of the (possibly inaccurate) location indicated by the IP address assigned to the mobile device 52. Upon determining the optimized route, the intelligent IP resolver 66 can return the IP address of the selected node 62 of the content provider 60 to the DNS server 68 in the external network 64 as an answer to the DNS request.

The DNS server 68 can, in some examples, cache the IP address of the selected node 62 of the content provider 60 for future content requests. Moreover, the DNS server 68 can return the IP address of the selected node 62 of the content provider 60 to the client 58 of the mobile device 52, such that requests to the domain name of the content provider 60 are resolved to the IP address provided by the intelligent IP resolver 66 which corresponds to the selected node 62 of the content provider 60. By employing this system 50, the mobile device 52 can establish a connection to the selected node 62 of the content provider 60 to retrieve the content in an efficient manner.

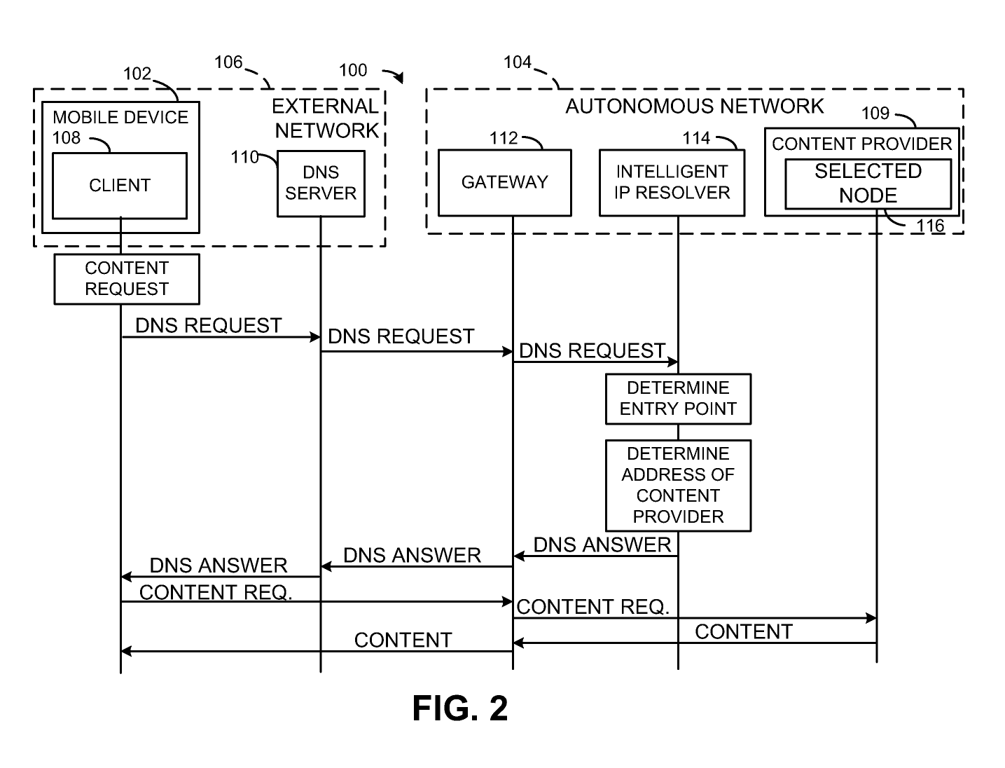

FIG. 2 illustrates an example of a system 100 for resolving a domain name for a mobile device 102 accessing an autonomous network 104. The mobile device 102 can be, for example, a wireless computing device. The mobile device 102 can be wirelessly connected to an external network 106, such as a mobile network (e.g., a cellular data network), a residential network, a WiFi network, etc.

The mobile device 102 can be assigned an IP address by the external network 106. The mobile device 102 can be executing a client 108 (e.g., an application), such as a browser, a dedicated application or a plugin. The client 108 can be configured to generate a content request in response, for example, to user input. To fulfill the content request, the client 108 of the mobile device 102 can specify a domain name of a content provider 109. The domain name can be provided in a DNS request to a DNS server 110 (e.g., a nameserver) associated with the mobile device 102. It is noted that in FIG. 2 the content provider 109 is illustrated as being implemented on the autonomous network 104, in other examples, the content provider 109 can be operating on an external system and/or network with one or more entry points into the autonomous network 104.

The DNS server 110 can provide the DNS request through a gateway 112 to an intelligent IP resolver 114 operating on the autonomous network 104. The gateway 112 can be representative, but is not limited a packet network gateway (P-GW) or a combination of a packet network gateway (P-GW) and a serving gateway (S-GW). In examples where a given gateway 112 serves as a combination of a packet network gateway and a serving gateway, the gateway 112 can be configured to have an IP point of presence in both the external networks and the autonomous network 104. Moreover, although FIG. 2 illustrates only a single gateway 112, in many examples, such as the system 50 of FIG. 1, the autonomous network 104 can have a plurality of gateways. In this manner, the intelligent IP resolver 114 can include features of an authoritative nameserver and/or another DNS server. Additionally, the intelligent IP resolver 114 can determine an entry point (e.g., an ingress and egress port) of the autonomous network 104. In this present example, the entry point can be a particular gateway, namely the gateway 112 through which the DNS request is provided from the DNS server 110. However, it is to be understood that in other examples, the intelligent IP resolver 114 can communicate with the DNS server 110 through a different gateway than the gateway 112 through which the mobile device 102 communicates.

The intelligent IP resolver 114 can determine the particular gateway 112 using several different processes. In some examples, the intelligent IP resolver 114 can send a control plane message to the external network 106 for information related to the architecture of the external network 106. In other examples, the intelligent IP resolver 114 can identify the IP address associated with the mobile device 102 to determine if the IP address for the mobile device 102 has been assigned by a network operator of the autonomous network 104. In these situations, the intelligent IP resolver 114 can send and receive responses to control plane messages to generate and/or access data characterizing network architectural features of the wireless network on which the mobile device 102 communicates. Such features can include, for example, an identity of the particular gateway 112 assigned to the external network 106.

In other examples, such as situations where the external network 106 operates independently of the autonomous network 104, the intelligent IP resolver 114 can initiate a “traceroute” (or similar) function toward the mobile device 102 and track a network route of messages within the autonomous network 104 until the particular gateway 112 (which communicates with the mobile device 102) is reached, so as to determine the particular gateway 112. The traceroute message can be implemented, for example, as a user plane message.

In either situation, an IP address of the particular gateway 112 can be employed as a proxy for the IP address of the mobile device 102 in a routing algorithm (e.g., OSPF or similar algorithm) to select a node 116 (a selected node 116) of the content provider 109 best suited to provide content to the client 108 of the mobile device 102. The determination can be based, for example on a weighted analysis of the availability of the selected node 116 of the content provider 109, the entry point (the particular gateway 112) and the network path between the particular gateway 112 and the selected node 116 of the content provider 109. The intelligent IP resolver 114 can determine the IP address of the selected node 116 of the content provider 109.

Upon determining the IP address of the selected node 116 of the content provider 109, the intelligent IP resolver 114 can provide a DNS answer to the DNS server 110 in response to the DNS request. The DNS answer can include the IP address of the selected node 116 of the content provider 109. The DNS server 110 can forward the DNS answer to the mobile device 102. In some examples, the DNS server 110 can also cache the DNS answer for future DNS requests.

Upon receipt of the DNS answer at the mobile device 102, the client 108 at the mobile device 102 can resolve the domain name for the content provider 109 to the IP address of the selected node 116 of the content provider 109. In particular, the client 108 of the mobile device 102 can send a content request (labeled in FIG. 2 as “CONTENT REQ.”) to the selected node 116 of the content provider 109 via the particular gateway 112. In response, the selected node 116 of the content provider 109 can send the requested content via the particular gateway 112 to the mobile device 102.

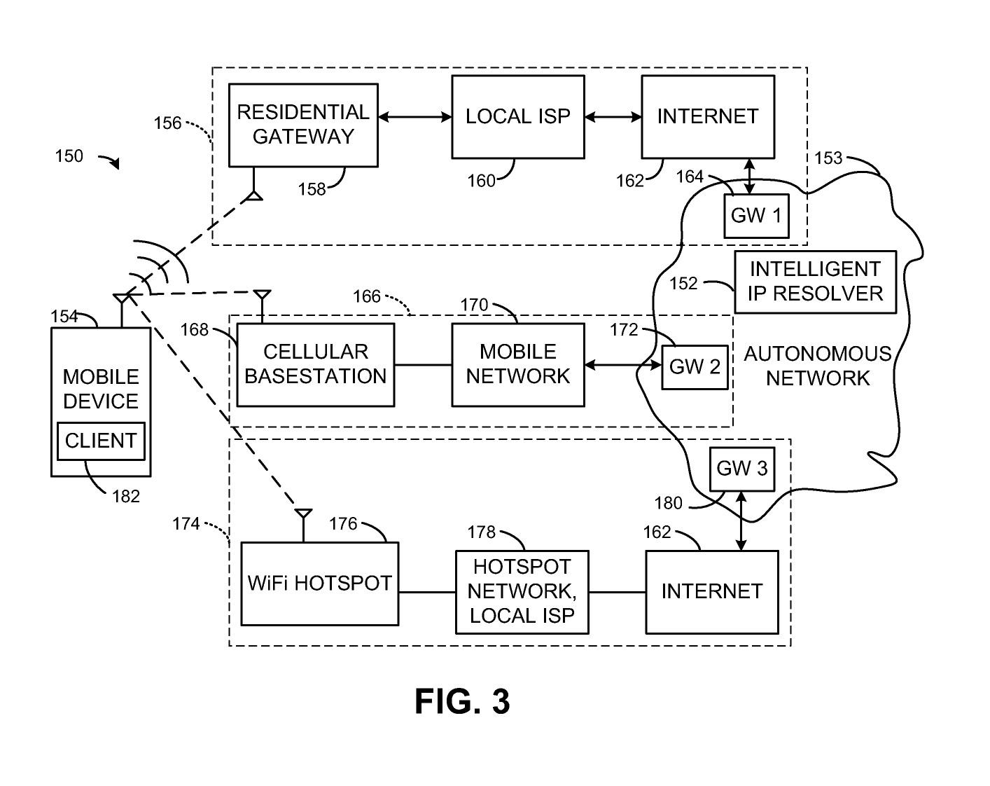

FIG. 3 illustrates a diagram of a network system 150 that benefits from the inclusion of an intelligent IP resolver 152, such as the intelligent IP resolver 66 illustrated in FIG. 1 and/or the intelligent IP resolver 114 illustrated in FIG. 2. The network system 150 can include a mobile device 154 (e.g., the mobile device 52 illustrated in FIG. 1 and/or the mobile device 102 illustrated in FIG. 2). The network system 150 illustrates three different network paths between the mobile device 154 and an autonomous network 153.

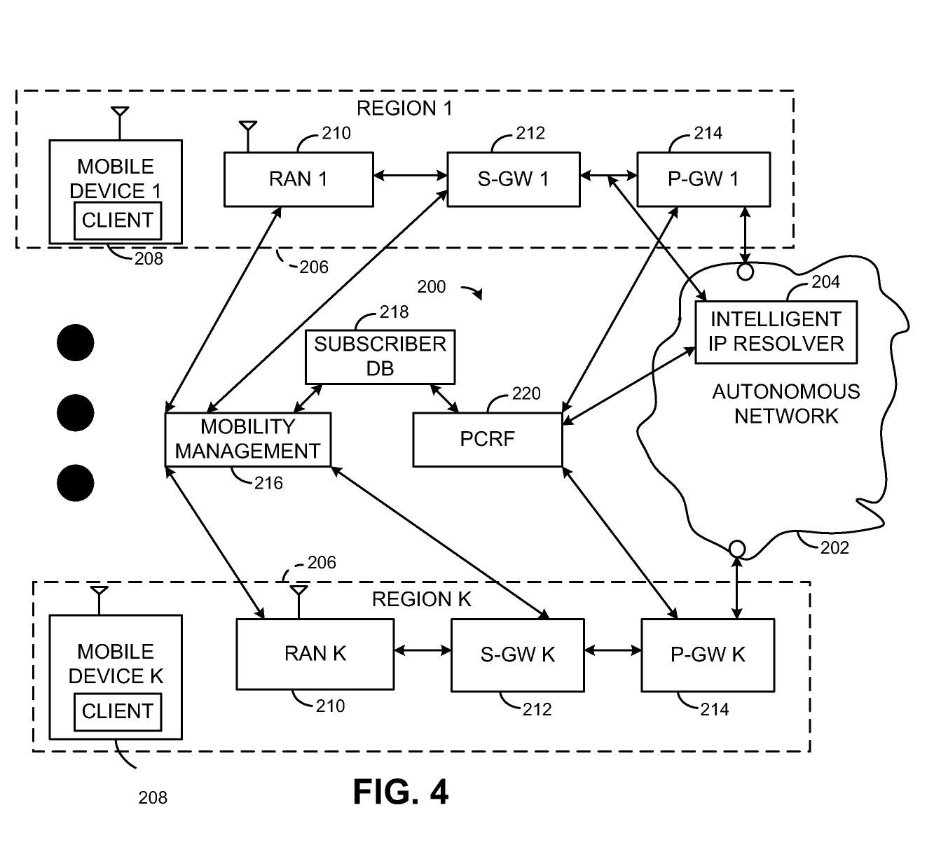

In a first path 156, the mobile device 154 can communicate with a residential gateway 158 (e.g., in a home network). The residential gateway 158 can communicate with a local Internet Service Provider (ISP) 160. The local ISP 160 can be connected to the Internet 162 that can be connected to the autonomous network 153 at a first gateway 164 (labeled as “GW 1” in FIG. 4). The first gateway 164 can be implemented, for example as one of the N number of gateways 56 illustrated in FIG. 1 and/or the gateway 112 illustrated in FIG. 2.

In a second path 166, the mobile device 154 can communicate with a cellular basestation 168 of a mobile network 170 (e.g., a cellular data network). The cellular basestation 168 can communicate through the mobile network 170 to a second gateway 172 (labeled in FIG. 4 as “GW 2”) on the autonomous network 153.

In a third path 174, the mobile device 154 can communicate with a WiFi hotspot 176. The WiFi hotspot 176 can be coupled to a hotspot network and/or a local ISP 178. The hotspot network and/or the local ISP 178 can communicate with the Internet to access the autonomous network at a third gateway 180 (labeled in FIG. 4 as “GW 3”).

A client 182 executing on the mobile device 154 can be configured to request content from a content provider operating on the autonomous network 153. As is illustrated in FIG. 3, the same mobile device 154 can communicate with the autonomous network 153 through 3 different network paths, using different gateways, namely, the first gateway 164, the second gateway 172 and the third gateway 180. Accordingly, for any content request initiated for a session, the content request from the same mobile device 154 can be provided on any of the first network path 156, the second network path 166 and the third network path 174.

As described herein, the intelligent IP resolver 152 can identify the particular gateway employed by the mobile device 154 at a specific session by employing control plane messaging or user plane messaging (e.g., a traceroute). Thus, the intelligent IP resolver 152 can select a node of the content provider suited to provide the requested content to the mobile device 154 based on the particular gateway, in a manner described herein. The intelligent IP resolver 152 can forward the IP address of the selected node of the content provider to the client of the mobile device 154. In this manner, the client 182 of the mobile device 154 can efficiently communicate with the content provider without relying on potentially inaccurate location information related to the mobile device 154 based on an IP address assigned to the mobile device 154.

FIG. 4 illustrates an example of a mobile network 200 that communicates with an autonomous network 202 that employs an intelligent IP resolver 204, such as the intelligent IP resolver 66 illustrated in FIG. 1 and/or the intelligent IP resolver 114 illustrated in FIG. 2. The mobile network 200 can be implemented, for example, as a long term evolution (LTE) network, a 3GPP network, a 3GPP2 network or other 3G based network operating on a wireless carrier. The autonomous network 202 could be implemented, for example, in a manner similar to the autonomous network 54 illustrated in FIG. 1 and/or the autonomous network 104 illustrated in FIG. 2.

The mobile network 200 can include K number of regions 206, where K is an integer greater than or equal to two. Each of the K number of regions 206 can communicate with a mobile device 208 via a radio access node (RAN) 210. Each RAN 210 can be connected to a serving gateway (S-GW) 212 that resides in the user plane where each serving gateway 212 can forward and route packets to and from an associated mobile device 208 (via the corresponding RAN 210) and a packet network gateway (P-GW) 214 of the corresponding region 206. Each serving gateway 212 can also serves as a local mobility anchor for inter-region handover and mobility within the mobile network 200. Each packet network gateway 214 can operate as an interface between the mobile network 200 and other packet data networks, such as the autonomous network 202.

The mobile network 200 can include control plane elements such as a mobility management function 216. The mobility management function 216 can be configured to manage session states, authentication, roaming, etc. A subscriber database 218 can be accessed by the mobility management function 216. The subscriber database 218 includes information related to each of the mobile devices 208 that communicate with the mobile network 200. The mobile network 200 can also include a policy and rules charging function (PCRF) 220. The PCRF 220 can be configured to interface with the packet network gateway 214 of each of the K number of regions 206. Moreover, the PCRF 220 can be configured to implement charging enforcement decisions.

As explained with respect to FIGS. 1 and 2, the intelligent IP resolver 204 can be configured to identify a particular gateway, such as one of the packet network gateways 214 through which a particular mobile device of the K number of mobile devices 208 devices is entering the autonomous network 202. In situations where the network is implemented as a mobile network 200, as illustrated in FIG. 4, the intelligent IP resolver 204 can send control plane messages to determine the particular gateway. In some examples, the particular gateway can be determined by querying the PCRF 220 for data associated with the particular mobile device. Additionally or alternatively, the intelligent IP resolver 204 can monitor control plane traffic provided to each of the K number of packet node gateways 214 to identify the particular mobile device communicating through a corresponding packet node gateway 214, which can be the particular gateway. By employing the mobile network 200, the intelligent IP resolver 204 can employ control plane messaging to determine the particular gateway, which, as noted, can be employed as an entry point to the autonomous network 202.

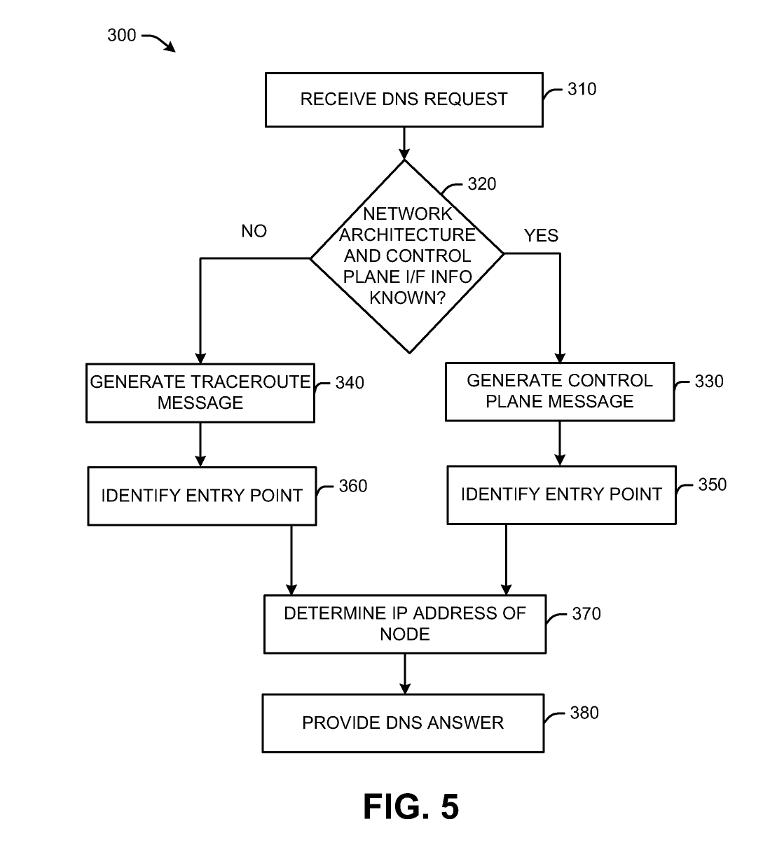

In view of the foregoing structural and functional features described above, example methods will be better appreciated with reference to FIG. 5. While, for purposes of simplicity of explanation, the example methods of FIG. 5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 5 can be implemented as instructions stored in a non-transitory machine-readable medium. The instructions can be accessed by a processing resource (e.g., one or more processor cores) and executed to perform the methods disclosed herein.

FIG. 5 illustrates an example flowchart of a method 300 for resolving a domain name. The method 300 could be implemented, for example, by the intelligent IP resolver 54 illustrated in FIG. 1 and/or the intelligent IP resolver illustrated in FIG. 2. At 310, a DNS request can be received, for example, from a DNS server on an external network, such as the DNS server 68 illustrated in FIG. 1 and/or the DNS server 110 illustrated in FIG. 2. The DNS request issued by the DNS server can include an IP address of a mobile device from which the DNS request originated. The DNS request can be a resolution request for an IP address of a content provider within or accessed via an autonomous network (e.g., the autonomous network 54 illustrated in FIG. 1 and/or the autonomous network 104 illustrated in FIG. 2).

At 320, a determination can be made (e.g., by the intelligent IP resolver) as to whether network architecture for the external network is known and whether control plane interface information (e.g., details such as protocol, control plane node address for querying, etc.) are known. The determination at 320 can be based, for example, on a response (or lack of response) to a control plane message provided to the external network, the IP address of the mobile device, etc. If the determination at 320 is positive (e.g., YES), the method 300 can proceed to 330. If the determination at 320 is negative (e.g., NO), the method 300 can proceed to 340.

At 330, a control plane message can be generated (e.g., by the intelligent IP resolver) to identify network architectural characteristics of the external network. The control plane message could be, for example, a query to a network node, such as a PCRF (e.g., the PCRF 220 illustrated in FIG. 4). Additionally or alternatively, the control plane message can monitor packets provided to a plurality of gateways (e.g., packet network gateways) that interface with the autonomous network. In either situation, at 350 the entry point of the autonomous network can be identified (e.g., by the intelligent IP resolver). The entry point can be set to the gateway through which the mobile device is communicating, which can be referred to as a particular gateway.

At 340, a traceroute (or similar) can be generated (e.g., by the intelligent IP resolver) user plane message directed to the mobile device. At 360, the traceroute can be analyzed (e.g., by the intelligent IP resolver), to identify the entry point of the autonomous network. The entry point can be, for example, a particular gateway between the autonomous network and the external network.

At 370, a routing algorithm can be employed (e.g., by the intelligent IP resolver), such as the OSPF algorithm, to determine an IP address of a node of the content provider that should be employed by the mobile device to receive content. The routing algorithm can employ, for example, an IP address of the entry point (e.g., the particular gateway) as a parameter corresponding to the location of the mobile device. The routing algorithm can also weigh parameters such as an availability of the nodes of the content provider. At 380, a DNS answer to the DNS server can be provided (e.g., by the intelligent IP resolver) that identifies the IP address of the node of the content provider. In this manner, the mobile device can resolve the domain name of the content provider to the IP address of the node of the content provider.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. An intelligent Internet Protocol (IP) resolver implemented on one or more computing devices having machine readable instructions, the intelligent IP resolver being configured to:
receive a domain name service (DNS) request from a node of an external network to resolve a domain name for a content provider accessed via an autonomous network;
determine an entry point into the autonomous network for traffic originating from a mobile device identified in the DNS request; and
generate a DNS answer that identifies a node of the content provider, wherein the node of the content provider is determined based on the entry point of the autonomous network.

2. The intelligent IP resolver of claim 1, wherein the intelligent IP resolver is further configured to provide a control plane message to a network node of the external network to determine the entry point of the autonomous network.

3. The intelligent IP resolver of claim 2, wherein the entry point of the autonomous network comprises a gateway to the autonomous network.

4. The intelligent IP resolver of claim 3, wherein the external network is a mobile network and the gateway comprises a packet network gateway.

5. The intelligent IP resolver of claim 4, wherein the mobile network comprises at least one of a Long Term Evolution (LTE) network, a 3GPP network and a 3GPP2 network.

6. The intelligent IP resolver of claim 1, wherein the intelligent IP resolver is further configured to execute a network routing algorithm that employs an IP address of a node of the entry point of the autonomous network as an estimate for a location of the mobile device to determine the node of the content provider.

7. The intelligent IP resolver of claim 1, wherein the intelligent IP resolver is further configured to execute a traceroute function toward the mobile device to determine the entry point of the autonomous network.

8. The intelligent IP resolver of claim 7, wherein the entry point of the autonomous network comprises a gateway to the autonomous network identified in the traceroute function.

9. The intelligent IP resolver of claim 8, wherein the external network comprises a WiFi network.

10. An autonomous network comprising:
a plurality of entry points to the autonomous network, wherein each entry point is coupled to a corresponding external network of a plurality of external networks; and
an intelligent IP resolver configured to:
receive a domain name service (DNS) request for a content provider comprising a plurality of nodes, wherein the DNS request identifies a mobile device operating on an external network; and
select a node of the content provider based on a particular entry point of the plurality of entry points in response to the DNS request, wherein traffic from the mobile device flows through the particular entry point into the autonomous network.

11. The autonomous network of claim 10, wherein the intelligent IP resolver is further configured to provide an answer to the DNS request that identifies the selected node of the content provider.

12. The autonomous network of claim 10, wherein each entry point of the plurality of entry points comprises a gateway.

13. The autonomous network of claim 10, wherein the intelligent IP resolver is further configured to determine the particular entry point of the plurality of entry points based on a control message provided to a network node.

14. The autonomous network of claim 10, wherein the intelligent IP resolver is further configured to determine the particular entry point of the plurality of entry points based on a traceroute function toward the mobile device.

15. The autonomous network of claim 10, wherein the content provider is configured to provide requested content to the mobile device in response to a content request directed to the selected node of the content provider.

16. A method comprising:
receiving a domain name service (DNS) request from a node of an external network to resolve a domain name for a content provider operating on an autonomous network;
determining whether network architecture and control plane interface information are known for the autonomous network;
identifying an entry point into the autonomous network for traffic originating from a mobile device identified in the DNS request, in response to the determination of whether the network architecture and the control plane interface information are known; and
determine an Internet Protocol (IP) address for a node of the content provider based on the entry point into the autonomous network.

17. The method of claim 16, further comprising generating a traceroute function toward the mobile device, wherein the entry point to the autonomous network comprises a gateway to the autonomous network identified by the traceroute function.

18. The method of claim 16, further comprising generating a control plane message comprising a query to a policy and charging function, wherein the entry point to the autonomous network comprises a packet node gateway identified in response to the query.

19. The method of claim 16, further comprising providing a DNS answer to the DNS request that identifies the IP address of the node of the content provider.

20. The method of claim 16, wherein the DNS request is received from a Long Term Evolution (LTE) network, a 3GPP network or a 3GPP2 network.
